(19) United States
(12) Patent Application Publication
(10) Pub. No.: US 2025/0296228 A1
(43) Pub. Date: Sep. 25, 2025

(54) CONTROL DEVICE, ROBOT SYSTEM, LEARNING DEVICE, AND RECORDING MEDIUM

(71) Applicant: Mitsubishi Electric Corporation, Chiyoda-ku, Tokyo (JP)

(72) Inventors: Yoshihiro HOSOKAWA, Chiyoda-ku, Tokyo (JP); Hiroki AMEMORI, Chiyoda-ku, Tokyo (JP); Saori MATSUNAGA, Chiyoda-ku, Tokyo (JP); Takanori HIROOKA, Chiyoda-ku, Tokyo (JP)

(73) Assignee: Mitsubishi Electric Corporation, Chiyoda-ku, Tokyo (JP)

(21) Appl. No.: 18/855,117

(22) PCT Filed: Sep. 22, 2022
(86) PCT No.: PCT/JP2022/035317

§ 371 Date: Oct. 8, 2024

(30) Foreign Application Priority Data
May 18, 2022 (JP) 2022-081457

(51) Int. Cl. B25J 9/16

(52) U.S. Cl. CPC B25J 9/163; B25J 9/1664

(57) ABSTRACT

A control device includes a data acquirer, a robot controller, and a first learner. The first learner calculates a geometric deformation of a first trajectory relative to a first ideal trajectory, based on data on the first trajectory and data on the first ideal trajectory. The first trajectory is an actual trajectory actually defined by a movement of the robot and the first ideal trajectory is an ideal trajectory preferably defined by a movement of the robot when the robot controller controls the robot in accordance with a first learning data set acquired by the data acquirer. The first learner generates a first correction model for correcting a piece of movement data and thus reducing the calculated geometric deformation, based on the calculated geometric deformation and the piece of data contained in the first learning data set.

### TECHNICAL FIELD

The present disclosure relates to a control device, a robot system, a learning device, a method of controlling a robot, and a program.

### BACKGROUND ART

Some robots include multiple links, and multiple joints connecting the links to each other, so as to achieve various movements. Such a robot performs a desired movement by means of control of servomotors for driving the respective joints. If these servomotors respond to an instruction at timings having mutually different delays, the resulting movement of the robot is deviated from the target movement. For example, the different delays may cause a trajectory of the distal link at the distal end among the links to be deviated from the target trajectory. In view of this situation, techniques for approaching the actual trajectory of the robot to the ideal trajectory have been developed.

For example, Patent Literature 1 discloses a teaching device that measures an actual trajectory of a robot, calculates teaching points for minimizing trajectory errors indicating the distances between the actual trajectory and the target trajectory on the basis of the trajectory errors, and teaches the robot the positions of the teaching points. The teaching device disclosed in Patent Literature 1 controls the robot in accordance with the teaching points, and thus reduces the trajectory errors.

### CITATION LIST

### Patent Literature

Patent Literature 1: Unexamined Japanese Patent Application Publication No. H11-048176

### SUMMARY OF INVENTION

### Technical Problem

The teaching device disclosed in Patent Literature 1 repeats the calculation of teaching points and the control of the robot in accordance with the teaching points, until the trajectory errors are reduced to an allowable limit or smaller. A complicated target trajectory provides an increased number of teaching points, resulting in an elongated time required for convergence of the trajectory errors to the allowable limit or smaller. The teaching device thus finds it difficult to approach the actual trajectory of the robot to such a complicated target trajectory, and cannot readily cause the robot to move with high accuracy.

The robot, which cannot readily move with high accuracy, cannot be readily managed.

An objective of the present disclosure, which has been accomplished to solve the above problem, is to provide a control device, a robot system, a learning device, a method of controlling a robot, and a program that can achieve highly accurate movements of the robot and facilitate management of the robot.

### Solution to Problem

In order to achieve the above objective, a control device according to the present disclosure includes a data acquirer, a robot controller, and a first learner. The data acquirer acquires a piece of movement data indicating an operational trajectory of a robot including at least a movement start point at which the robot starts a movement and a movement end point at which the robot ends the movement, or a first learning data set containing a piece of data indicating a first learning trajectory of the robot including at least a first learning movement start point at which the robot starts a movement and a first learning movement end point at which the robot ends the movement. The robot controller controls the robot in accordance with the piece of movement data or the first learning data set acquired by the data acquirer. The first learner calculates, from apiece of data on a first trajectory and a piece of data on a first ideal trajectory, a geometric deformation of the first trajectory relative to the first ideal trajectory, the first trajectory being an actual trajectory actually defined by a movement of the robot and the first ideal trajectory being an ideal trajectory preferably defined by a movement of the robot when the robot controller controls the robot in accordance with the first learning data set acquired by the data acquirer, and generates, based on the calculated geometric deformation and the piece of data contained in the first learning data set, a first correction model for correcting the piece of movement data and thus reducing the calculated geometric deformation. When the robot controller controls the robot in accordance with the piece of movement data acquired by the data acquirer, the robot controller corrects the piece of movement data using the first correction model, and thus calculates a piece of corrected movement data, and controls the robot in accordance with the piece of corrected movement data.

### Advantageous Effects of Invention

The robot controller in the present disclosure, when controlling the robot in accordance with the piece of movement data acquired by the data acquirer, corrects the piece of movement data using the first correction model for reducing a geometric deformation, which is generated by the first learner, and thus calculates a piece of corrected movement data, and controls the robot in accordance with the piece of corrected movement data. This control device can cause the robot to move with high accuracy. The highly accurate movements of the robot can facilitate management of the robot.

### BRIEF DESCRIPTION OF DRAWINGS

FIG. 1 is a perspective view of a robot controlled by a control device according to Embodiment 1 of the present disclosure;

FIG. 2 is a side view of the robot controlled by the control device according to Embodiment 1 of the present disclosure;

FIG. 3 illustrates a hardware configuration of the control device according to Embodiment 1 of the present disclosure;

FIG. 4 is a block diagram illustrating the control device according to Embodiment 1 of the present disclosure;

FIG. 5 is a flowchart illustrating a learning process executed by the control device according to Embodiment 1 of the present disclosure;

FIG. 6 is a flowchart illustrating a first subprocess involved in the learning process executed by the control device according to Embodiment 1 of the present disclosure;

FIG. 7 illustrates an exemplary first learning data set used in the first subprocess involved in the learning process executed by the control device according to Embodiment 1 of the present disclosure;

FIG. 8 is a conceptual diagram illustrating trajectories indicated by the first learning data set used in the first subprocess involved in the learning process executed by the control device according to Embodiment 1 of the present disclosure;

FIG. 9 is a flowchart illustrating a second subprocess involved in the learning process executed by the control device according to Embodiment 1 of the present disclosure;

FIG. 10 illustrates an exemplary second learning data set used in the second subprocess involved in the learning process executed by the control device according to Embodiment 1 of the present disclosure;

FIG. 11A is a conceptual diagram illustrating an actual trajectory and an ideal trajectory of the robot, calculated in the second subprocess involved in the learning process executed by the control device according to Embodiment 1 of the present disclosure;

FIG. 11B is a conceptual diagram illustrating a relationship between an error of a correction trajectory and an error of an actual trajectory, calculated in the second subprocess involved in the learning process executed by the control device according to Embodiment 1 of the present disclosure;

FIG. 11C is a conceptual diagram illustrating a distribution of errors of the correction trajectory and a distribution of errors of the actual trajectory, calculated in the second subprocess involved in the learning process executed by the control device according to Embodiment 1 of the present disclosure;

FIG. 11D is a conceptual diagram illustrating the correction trajectory calculated in the second subprocess involved in the learning process executed by the control device according to Embodiment 1 of the present disclosure;

FIG. 11E is a conceptual diagram illustrating an actual trajectory when the robot moves in accordance with the correction trajectory calculated in the second subprocess involved in the learning process executed by the control device according to Embodiment 1 of the present disclosure;

FIG. 12 is a flowchart illustrating an operating process executed by the control device according to Embodiment 1 of the present disclosure; and

FIG. 13 is a conceptual diagram illustrating a distribution of errors of an actual trajectory used in a second subprocess involved in a learning process executed by a control device according to Embodiment 2 of the present disclosure.

### DESCRIPTION OF EMBODIMENTS

A control device, a robot system, a learning device, a method of controlling a robot, and a program according to Embodiment 1 of the present disclosure are described in detail below with reference to the accompanying drawings. In the drawings, the components identical or corresponding to each other are provided with the same reference symbol. The drawings are provided with an orthogonal coordinate system XYZ, in which the Z axis corresponds to the vertical direction and the XY plane corresponds to the horizontal direction when the axis of a base of the robot extends in the vertical direction and the main surfaces of a stabilizer extends in parallel to the horizontal direction.

### Embodiment 1

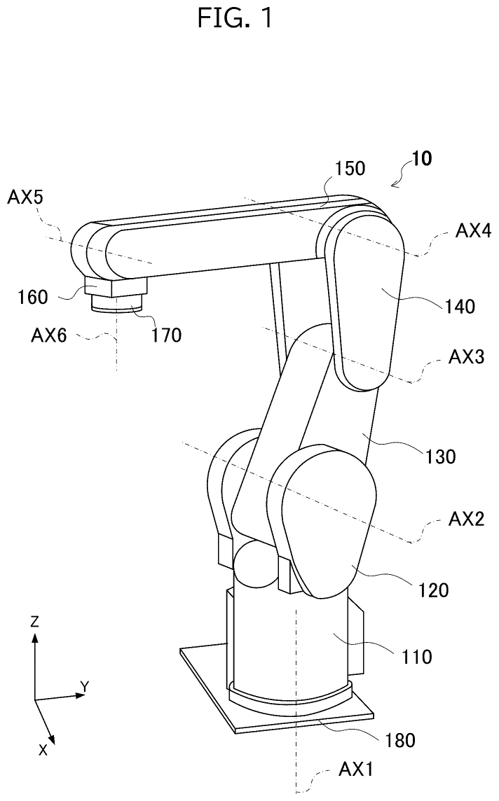

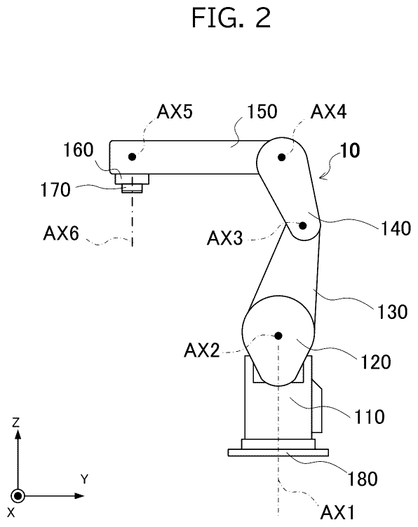

In order to control a robot with higher accuracy, the control device according to Embodiment 1 executes a learning process for correcting geometric deviations of the actual trajectory of the robot from the ideal trajectory, in advance of operation of the robot. The following describes a configuration of the control device focusing on an example in which the control device controls a vertical articulated robot. First, a structure of the vertical articulated robot to be controlled is described below, with reference to FIGS. 1 and 2.

FIG. 1 is a perspective view of a robot 10 controlled by the control device according to Embodiment 1. FIG. 2 is a side view of the robot 10.

As illustrated in FIGS. 1 and 2, the robot 10 includes a base 110, a first arm 120, a second arm 130, a third arm 140, a fourth arm 150, a fifth arm 160, and a flange 170, each of which serves as a link.

The base 110 has a columnar shape, of which the axis AX1 extends in the vertical direction, that is, the Z direction. The −Z end of the base 110 is provided with a stabilizer 180 having a flat-plate shape. The stabilizer 180 is fixed at an installation site having a horizontal surface, that is, a surface parallel to the XY plane. The stabilizer 180 thus stabilizes the base 110 at the installation site. In contrast, the +Z end of the base 110 is coupled to the first arm 120.

The first arm 120 is coupled to the base 110 such that the first arm 120 can turn about the axis AX1 extending in the Z direction. The second arm 130 is coupled to the first arm 120 and can turn about the axis AX2 extending in the horizontal direction. The third arm 140 is coupled to the second arm 130 and can turn about the axis AX3 extending in the horizontal direction. The fourth arm 150 is coupled to the third arm 140 and can turn about the axis AX4 extending in the horizontal direction. The fifth arm 160 is coupled to the fourth arm 150 and can turn about the axis AX5 extending in the horizontal direction. The flange 170 is coupled to the fifth arm 160 and can turn about the axis AX6, which extends from the axis AX5 in the radial direction of a virtual circle having the center at the axis AX5. The flange 170 can receive a processing tool, such as cutting tool or grinding tool, attached thereto.

The robot 10 having the above-described structure includes six joints associated with the respective axes AX1 to AX6. The robot 10 also includes motors M1 to M6, which are not illustrated in FIGS. 1 and 2, at the respective joints, so as to cause the first to fifth arms 120 to 160 and the flange 170 to turn about the axes AX1 to AX6. The motors M1 to M6 each rotate by a desired rotational angle, and thus allow the robot to shift the flange 170 to a desired position. For example, the robot 10 shifts a tool attached to the flange 170 to the desired position. By causing the respective rotational angles of the motors M1 to M6 to vary with time, the robot 10 moves the flange 170 from a certain movement start point to a certain movement end point along a desired trajectory.

The motors M1 to M6 respond to an instruction from the control device with some delays. If such delays in the response are different among the motors M1 to M6, the delays may cause the trajectory of the flange 170, that is, the trajectory of the robot 10 to be deviated from the ideal trajectory.

In view of this problem, the control device executes a learning process for correcting geometric deviations of the actual trajectory of the robot 10 from the ideal trajectory, in advance of operation for actual movements of the robot 10. The control device then executes an operating process for actual movements of the robot 10 on the basis of the learning process.

This specification defines the learning process as a process of generating data for correcting deviations of the actual trajectory from the ideal trajectory. This learning process, which is a kind of a so-called robot teaching process, is also called a teaching process. The learning process uses learning data, which is also called teaching data.

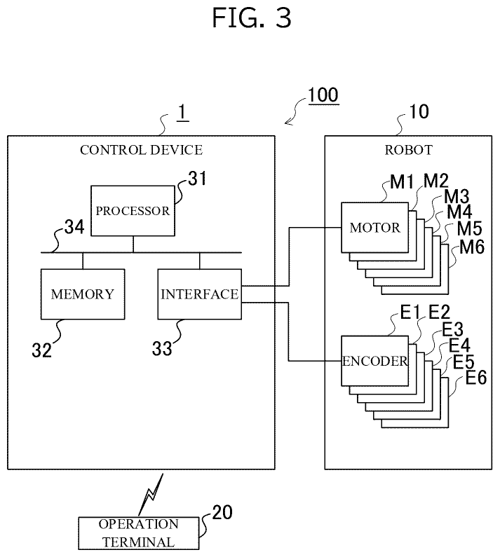

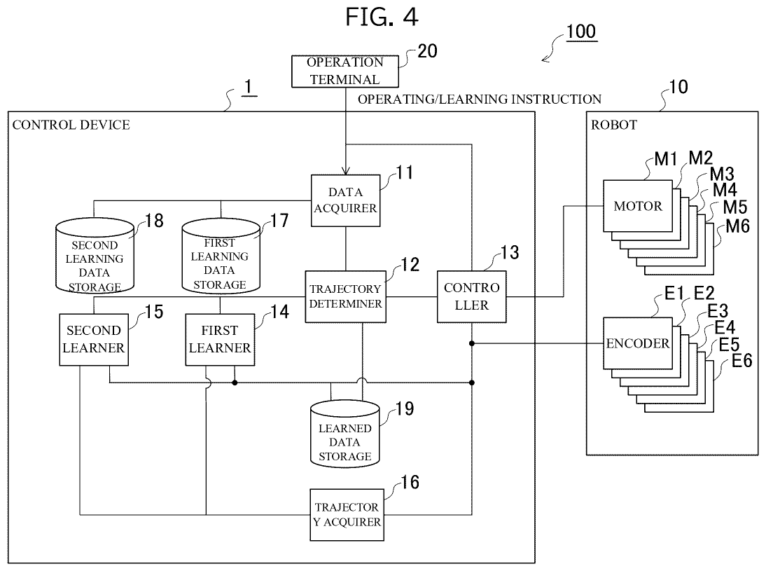

The following describes a configuration of the control device, which executes the learning process and the operating process, with reference to FIGS. 3 and 4.

FIG. 3 illustrates a hardware configuration of a control device 1 according to Embodiment 1. FIG. 4 is a block diagram illustrating the control device 1. FIGS. 3 and 4 each illustrate the entire configuration of a robot system 100 including the robot 10 and the control device 1, in order to facilitate an understanding.

As illustrated in FIG. 3, the control device 1 includes a processor 31, a memory 32, and an interface 33. The processor 31, the memory 32, and the interface 33 are connected to each other via buses 34.

The interface 33 connects the processor 31 and the memory 32 to external devices and enables the processor 31 and the memory 32 to communicate with the external devices. In detail, the interface 33 is connected to a wireless module, which is not illustrated. This interface 33 enables the processor 31 and the memory 32 to communicate with an operation terminal 20 via the Internet, as illustrated in FIG. 3. The interface 33 is also connected to the motors M1 to M6 and the encoders E1 to E6 of the robot 10.

The motors M1 to M6 serve to turn the first arm 120, the second arm 130, the third arm 140, the fourth arm 150, the fifth arm 160, and the flange 170 about the respective axes AX1 to AX6 illustrated in FIGS. 1 and 2. The motors M1 to M6 are made of servomotors for controlling the respective rotational positions of the first arm 120, the second arm 130, the third arm 140, the fourth arm 150, the fifth arm 160, and the flange 170. The motors M1 to M6 rotate and thus actuate the above-mentioned joints of the robot 10.

The encoders E1 to E6 detect the respective rotational angles of the shafts of the motors M1 to M6, in detail, the respective rotational positions of the shafts. The encoders E1 to E6 thus detect motions of the joints.

Referring back to FIG. 3, the motors M1 to M6 and the encoders E1 to E6 are connected to the interface 33, which allows for data transmission from the motors M1 to M6 and the encoders E1 to E6 to the processor 31 and the memory 32 and vice versa.

The processor 31 and the memory 32 constitute a computer. The processor 31 reads and executes various programs stored in the memory 32, so that the control device 1 executes various processes for controlling the motors M1 to M6 and the encoders E1 to E6 of the robot 10.

For example, the control device 1 reads and executes a learning program stored in the memory 32, and thus executes the learning process for correcting deviations of the actual trajectory of the robot 10. The control device 1 reads and executes an operating program stored in the memory 32, and thus executes the operating process for the robot 10 on the basis of the learning process. To execute the learning process and the operating process, the control device 1 includes functional components illustrated in FIG. 4 configured in the form of software. In detail, the control device 1 includes a data acquirer 11, a trajectory determiner 12, a controller 13, a first learner 14, a second learner 15, and a trajectory acquirer 16. These functional components are described below.

To execute the learning process, the control device 1 receives a learning instruction input from an input unit of the operation terminal 20. To execute the operating process, the control device 1 receives an operating instruction input from the input unit. The following description refers to a period of execution of the learning process in response to input of the learning instruction as “during the learning process”, and refers to a period of execution of the operating process in response to input of the operating instruction as “during the operating process”.

The data acquirer 11 acquires pieces of movement data from a first learning data storage 17 and a second learning data storage 18, during the learning process.

In detail, the first learning data storage 17 preliminarily stores a first learning data set containing pieces of movement data to be used during the learning process. The second learning data storage 18 preliminarily stores a second learning data set containing other pieces of movement data on the robot 10 to be used during the learning process. The data acquirer 11 reads the first learning data set or the second learning data set from the first learning data storage 17 or the second learning data storage 18, and acquires the pieces of movement data contained in the read data set, during the learning process.

The above-mentioned operating instruction input from the input unit of the operation terminal 20 contains apiece of movement data. The data acquirer 11 also acquires the piece of movement data from the input operating instruction, during the operating process.

The pieces of movement data each indicate an operational trajectory of the robot 10 that contains at least a movement start point at which the robot 10 starts a movement and a movement end point at which the robot 10 ends the movement. In detail, the piece of movement data contains at least the coordinates of the movement start point and the coordinates of the movement end point of the flange 170 of the robot 10, and also contains the coordinates of halfway points through which the flange 170 is expected to move between the movement start point and the movement end point. The piece of movement data is also called driving conditions.

When acquiring a piece of movement data, the data acquirer 11 outputs the acquired piece of movement data to the trajectory determiner 12.

The trajectory determiner 12 determines a trajectory of the robot 10, that is, a trajectory of the flange 170, on the basis of the piece of movement data received from the data acquirer 11.

In detail, the trajectory determiner 12 determines a trajectory of the flange 170 during the learning process, on the basis of the piece of movement data contained in the first learning data set or the second learning data set and received from the data acquirer 11. The trajectory determiner 12 then outputs apiece of data on the determined trajectory to the controller 13.

The trajectory determiner 12 determines a trajectory of the flange 170 during the operating process, using a first correction model and a second correction model stored in the learned data storage 19. In detail, the learned data storage 19 preliminarily stores the first correction model and the second correction model, generated by the first learner 14 and the second learner 15 as described below. The trajectory determiner 12 reads the first correction model and the second correction model from the learned data storage 19, corrects the piece of movement data received from the data acquirer 11 using the read first correction model and second correction model, and determines a trajectory of the flange 170, during the operating process. The trajectory determiner 12 thus corrects deviations of the actual trajectory of the flange 170 from the ideal trajectory that exist during the operating process. The trajectory determiner 12 then outputs a piece of data on the determined trajectory to the controller 13.

The controller 13 causes each of the motors M1 to M6 of the robot 10 to rotate, in accordance with the piece of data on the trajectory received from the trajectory determiner 12. The controller 13 thus causes the robot 10 to perform a movement based on a piece of movement data contained in the first learning data set or the second learning data set, during the learning process. The controller 13 also causes the robot 10 to perform a movement based on the piece of data on the trajectory after correction of the deviations, during the operating process.

The first learner 14 provides an instruction to the controller 13, and thus causes the robot 10 to perform a movement based on a piece of movement data contained in the first learning data set, during the learning process. The first learner 14 also provides an instruction to the trajectory acquirer 16, and thus causes the trajectory acquirer 16 to acquire a piece of data on the trajectory defined by a movement of the robot 10, during the learning process.

The trajectory acquirer 16 acquires, from the encoders E1 to E6 of the robot 10, the respective rotational positions of the motors M1 to M6 detected by the encoders E1 to E6, in accordance with the instruction from the first learner 14. The trajectory acquirer 16 continues to acquire the respective rotational positions of the motors M1 to M6 while the instruction is being provided from the first learner 14. The trajectory acquirer 16 calculates positions of the flange 170 of the robot 10 from the acquired rotational positions of the motors M1 to M6, and then calculates an actual trajectory of the flange 170. The trajectory acquirer 16 outputs apiece of data on the calculated actual trajectory to the first learner 14.

The first learner 14 regards the piece of data on the trajectory received from the trajectory determiner 12, as apiece of data on the ideal trajectory. The first learner 14 compares this piece of data on the ideal trajectory with a piece of data on an actual trajectory received from the trajectory acquirer 16, and then calculates a geometric deformation of the actual trajectory relative to the ideal trajectory, during the learning process.

The first learner 14 calculates how the actual trajectory is geometrically deformed relative to the ideal trajectory, for example, how the actual trajectory is deformed through geometric transformation, such as translation, rotation, and magnification or demagnification, although this step is described in detail below. The first learner 14 causes a piece of data on the calculated geometric deformations to be stored into the learned data storage 19, in the form of the first correction model for correcting the actual trajectory.

After completion of the learning by the first learner 14 during the learning process, the second learner 15 provides an instruction to the controller 13, and thus causes the robot 10 to perform a movement and define the trajectory determined on the basis of a piece of movement data contained in the second learning data set. The second learner 15 also provides an instruction to the trajectory acquirer 16, and thus causes the trajectory acquirer 16 to acquire a piece of data on the trajectory defined by the movement of the robot 10, like the first learner 14.

The second learner 15 acquires the piece of data on the actual trajectory from the trajectory acquirer 16. The second learner 15 regards the piece of data on the trajectory received from the trajectory determiner 12, as a piece of data on the ideal trajectory. The second learner 15 compares this piece of data on the ideal trajectory with the piece of data on the actual trajectory, and thus calculates positional deviations of the individual segments of the actual trajectory from the corresponding segments of the ideal trajectory. The second learner 15 causes apiece of data on the calculated positional deviations to be stored into the learned data storage 19, in the form of the second correction model for correcting the actual trajectory, although this step is described in detail below.

As described above, the trajectory determiner 12 corrects apiece of movement data input from the input unit, using the first correction model and the second correction model stored in the learned data storage 19, and determines a trajectory of the robot 10, during the operating process. In accordance with the trajectory indicated by the piece of corrected movement data, the controller 13 causes each of the motors M1 to M6 to rotate. The control device 1 thus approaches the actual trajectory of the robot 10 to the ideal trajectory. The control device 1 accordingly corrects the deviations of the actual trajectory from the ideal trajectory.

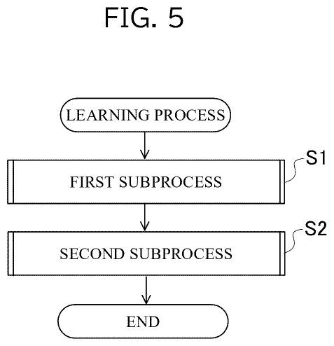

The learning process and the operating process executed by the control device 1 are described in more detail below, with reference to FIGS. 5 to 10, 11A to 11E, and 12. The following first describes the learning process executed by the control device 1.

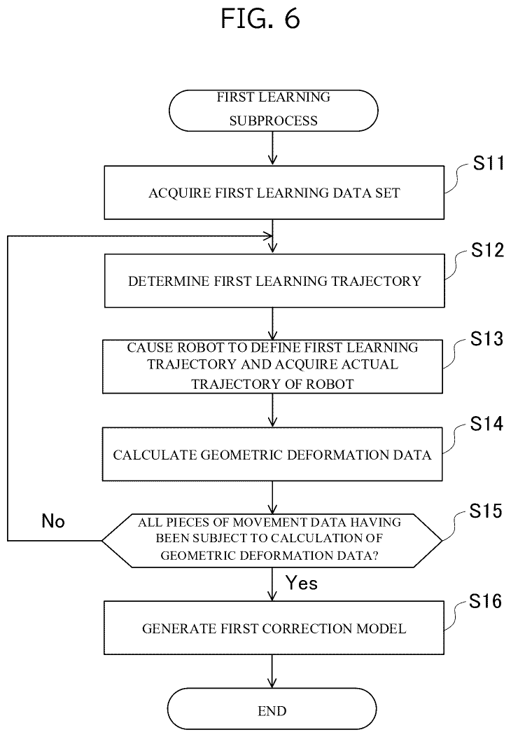

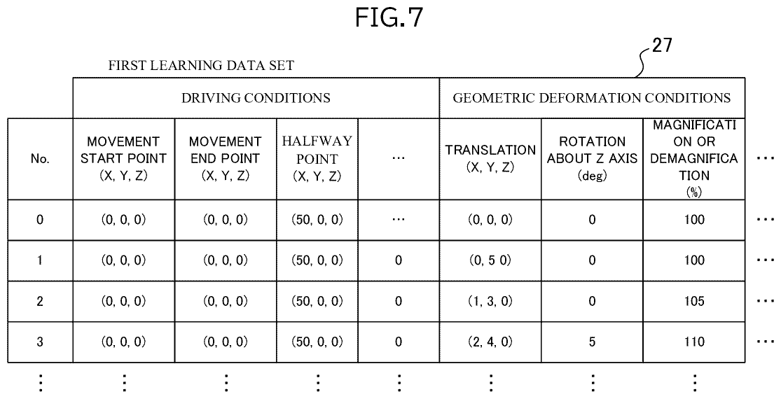

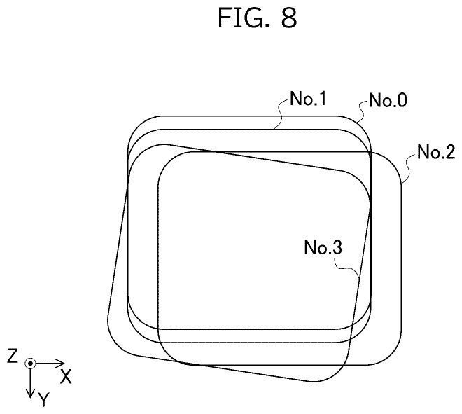

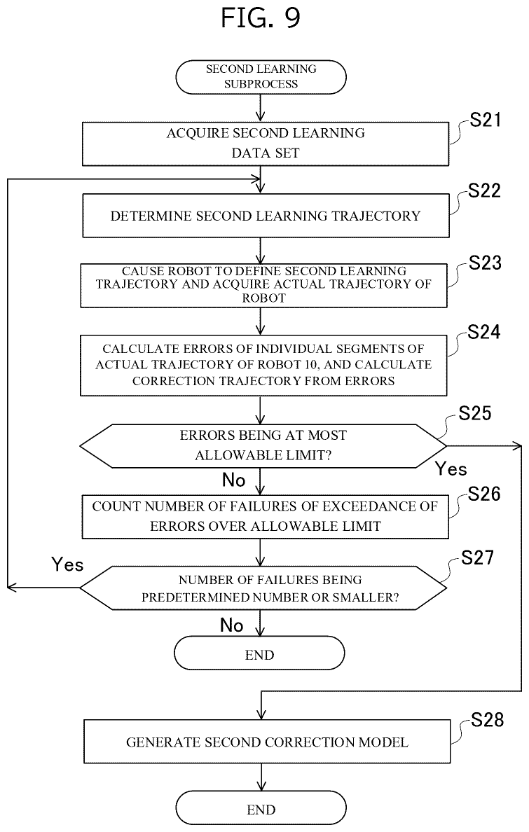

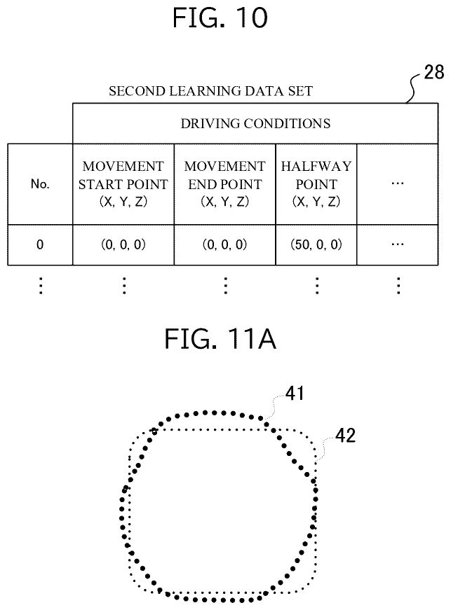

FIG. 5 is a flowchart illustrating the learning process executed by the control device 1. FIG. 6 is a flowchart illustrating a first subprocess involved in the learning process. FIG. 7 illustrates an exemplary first learning data set 27 used in the first subprocess. FIG. 8 is a conceptual diagram illustrating trajectories indicated by the first learning data set 27. FIG. 9 is a flowchart illustrating a second subprocess involved in the learning process. FIG. 10 illustrates an exemplary second learning data set 28 used in the second subprocess.

First, a user inputs a learning instruction through the input unit of the operation terminal 20. In response to input of the learning instruction, the processor 31 of the control device 1 reads and executes the learning program stored in the memory 32. The execution of the learning program initiates the learning process.

The initiation of the learning process is followed by a first subprocess, as illustrated in FIG. 5 (Step S1).

In the first subprocess, the data acquirer 11 first acquires the first learning data set 27, as illustrated in FIG. 6 (Step S11).

In detail, the data acquirer 11 reads the first learning data set 27, which contains pieces of movement data on the robot 10 and is stored in the first learning data storage 17.

As illustrated in FIG. 7, the first learning data set 27 associates driving conditions, that is, pieces of movement data for defining trajectories each represented by the movement start point, movement end point, and halfway points, with geometric deformation conditions of the trajectories. The geometric deformation conditions contain translation, rotation about the Z axis, and magnification or demagnification, for example.

The rotation about the Z axis indicates geometric transformation of turning a trajectory about the Z axis. The geometric deformation of a trajectory indicates deformation of a trajectory through geometric transformation, such as translation, rotation, and magnification or demagnification.

The first learning data set 27 is described in more detail below focusing on the examples illustrated in FIGS. 7 and 8. No. 0 indicates a trajectory starting from the movement start point (0, 0, 0), passing through the halfway point (50, 0, 0) and other halfway points, and returning to the movement end point (0, 0, 0) at the same coordinates as the movement start point, in which three numerals indicate XYZ coordinates. Assuming that No. 0 indicates a standard trajectory, No. 1 indicates a trajectory deformed through translation of the standard trajectory by a distance of 5 in the Y direction. No. 2 indicates a trajectory deformed through translation of the standard trajectory by a distance of 1 in the X direction and by a distance of 3 in the Y direction, as well as magnification of 105%. No. 3 indicates a trajectory deformed through translation of the standard trajectory by a distance of 2 in the X direction and by a distance of 4 in the Y direction, as well as rotation about the Z axis by an angle of 5° and magnification of 110%. These examples illustrate how the first learning data set 27 associates pieces of data on the trajectories with geometric deformation conditions of the trajectories.

The data acquirer 11 reads this first learning data set 27. The data acquirer 11 then calculates pieces of data on the coordinates of the individual trajectories, from the geometric deformation conditions associated with the standard trajectory in the read first learning data set 27. The data acquirer 11 thus acquires pieces of movement data on the robot 10 for defining the individual trajectories.

The trajectory determiner 12 then determines a first learning trajectory, as illustrated in FIG. 6 (Step S12). In detail, the trajectory determiner 12 calculates pieces of data on the coordinates of the trajectories, from the geometric deformation conditions associated with the trajectories indicated by the first learning data set 27 acquired by the data acquirer 11. The trajectory determiner 12 then selects one of the acquired trajectories, and regards the selected trajectory as a first learning trajectory. The trajectory determiner 12 thus determines a first learning trajectory which the robot 10 is to move in accordance with.

The determination of a first learning trajectory is followed by a movement of the robot 10 in accordance with the first learning trajectory, and acquisition of the actual trajectory of the robot 10 (Step S13). In detail, the controller 13 causes the robot 10 to move in accordance with the first learning trajectory determined by the trajectory determiner 12. The trajectory acquirer 16 then acquires apiece of data on the actual trajectory of this robot 10. Specifically, the trajectory acquirer 16 includes a clock and measures time with this clock. The trajectory acquirer 16 acquires, from the encoders E1 to E6 of the robot 10, the respective rotational positions of the shafts of the motors M1 to M6 detected by the encoders E1 to E6 after every certain period, during movement of the robot 10. The trajectory acquirer 16 then calculates positions of the flange 170 of the robot 10 at the individual time points, from the acquired rotational positions of the shafts of the motors M1 to M6. The trajectory acquirer 16 then calculates an actual trajectory of the flange 170 from the calculated positions of the flange 170. The trajectory acquirer 16 thus acquires the actual trajectory of the robot 10.

After the acquisition of the actual trajectory of the robot 10 by the trajectory acquirer 16, the first learner 14 calculates a piece of geometric deformation data from the piece of data on the actual trajectory (Step S14). In detail, the first learner 14 regards the first learning trajectory determined by the trajectory determiner 12 as an ideal trajectory, compares the piece of data on the ideal trajectory with the piece of data on the actual trajectory acquired by the trajectory acquirer 16, and calculates how the actual trajectory is geometrically deformed relative to the ideal trajectory. For example, the first learner 14 calculates how much the actual trajectory is translated, rotated, and magnified or demagnified relative to the ideal trajectory.

The first learner 14 then determines whether the pieces of movement data have all been subject to the calculation of geometric deformation data (Step S15). In detail, the data acquirer 11 acquires all the pieces of movement data contained in the first learning data set 27 in Step S11, as described above. The first learner 14 determines whether these pieces of movement data acquired from the data acquirer 11 have all been subject to the calculation of geometric deformation data in Step S14.

When the first learner 14 determines that not all the pieces of movement data have been subject to the calculation of geometric deformation data (Step S15; No), the process returns to Step S12. The trajectory determiner 12 then selects another one trajectory among the remaining ones of the trajectories acquired in Step S12, and regards the selected trajectory as a first learning trajectory. The trajectory determiner 12 thus determines anew first learning trajectory. Steps S12 to S15 are repeated in this manner, and can achieve calculation of geometric deformation data for all the trajectories acquired in Step S12.

In contrast, when the first learner 14 determines that all the pieces of movement data have been subject to the calculation of geometric deformation data (Step S15; Yes), the first learner 14 generates a first correction model (Step S16). In detail, the first learner 14 causes a table that associates the calculated pieces of geometric deformation data with the trajectories indicated by the first learning data set 27, to be stored into the learned data storage 19 in the form of the first correction model for correcting the actual trajectory. The first learner 14 thus generates the first correction model.

The first learner 14 may generate a first correction model for each of the pieces of geometric deformation data on the trajectories, or generate a single first correction model for all the pieces of geometric deformation data on the trajectories.

After the generation of the first correction model by the first learner 14, the first subprocess is terminated.

Referring back to FIG. 5, the first subprocess in Step S1 is followed by a second subprocess (Step S2).

In the second subprocess, the data acquirer 11 first acquires the second learning data set 28, as illustrated in FIG. 9 (Step S21).

In detail, the data acquirer 11 reads the second learning data set 28 stored in the second learning data storage 18. As illustrated in FIG. 10, the second learning data set 28 contains driving conditions of a trajectory corresponding to the standard trajectory contained in the first learning data set 27. Specifically, the second learning data set 28 indicates the coordinates of the movement start point, movement end point, and halfway points existing therebetween of a trajectory corresponding to the trajectory No. 0 contained in the first learning data set 27. The data acquirer 11 reads this second learning data set 28.

The trajectory determiner 12 then determines a second learning trajectory (Step S22). The second subprocess involves calculating errors of the individual segments of the actual trajectory of the robot 10, and calculating a correction trajectory from the calculated errors, as is described below in Step S24. In the step of determining a second learning trajectory, when the trajectory indicated by the second learning data set 28 read in Step S21 has not yet been subject to the calculation of a correction trajectory in Step S24, the trajectory determiner 12 regards the read trajectory indicated by the second learning data set 28 as a second learning trajectory. In contrast, when the trajectory indicated by the second learning data set 28 read in Step S21 has already been subject to the calculation of a correction trajectory in Step S24, the trajectory determiner 12 regards the calculated correction trajectory as a second learning trajectory. The trajectory determiner 12 thus determines a second learning trajectory.

The determination of a second learning trajectory is followed by a movement of the robot 10 in accordance with the second learning trajectory, and acquisition of the actual trajectory of the robot 10 (Step S23). This step is identical to Step S13 of the first subprocess except for that the movement is performed in accordance with the second learning trajectory, and is thus not redundantly described.

After the acquisition of the actual trajectory of the robot 10 in Step S23, the second learner 15 calculates errors of the individual segments of the actual trajectory of the robot 10, and calculates a correction trajectory from the calculated errors (Step S24).

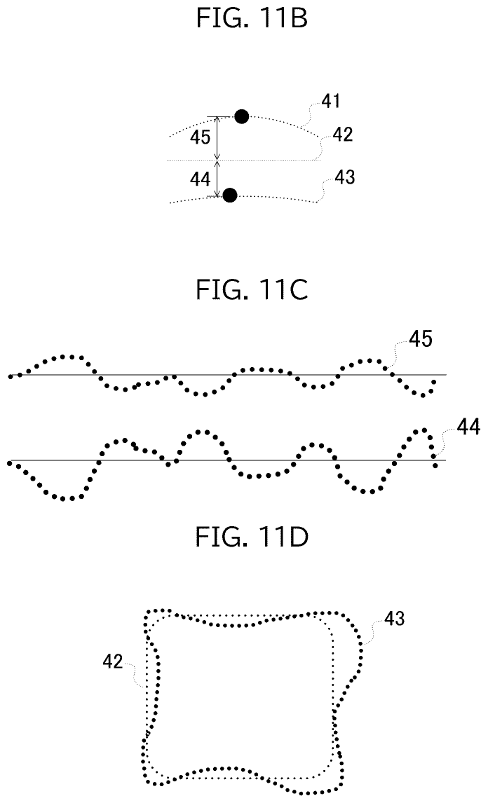

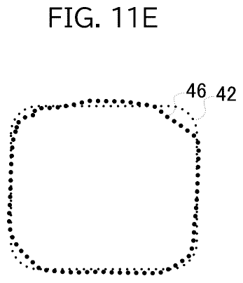

The calculation of errors and the calculation of a correction trajectory from the calculated errors in Step S24 are described in detail below with reference to FIGS. 11A to 11E.

FIG. 11A is a conceptual diagram illustrating an actual trajectory 41 and an ideal trajectory 42 of the robot 10, calculated in the second subprocess involved in the learning process. FIG. 11B is a conceptual diagram illustrating a relationship between an error 44 of the correction trajectory 43 and an error 45 of the actual trajectory 41, calculated in the second subprocess. FIG. 11C is a conceptual diagram illustrating a distribution of the errors 44 of the correction trajectory 43 and a distribution of the errors 45 of the actual trajectory 41, calculated in the second subprocess. FIG. 11D is a conceptual diagram illustrating the correction trajectory 43. FIG. 1E is a conceptual diagram illustrating an actual trajectory 46 when the robot 10 moves in accordance with the correction trajectory 43.

In general, as illustrated in FIG. 11A, the individual segments of the actual trajectory 41 acquired in Step S23 are often deviated from the corresponding segments of the ideal trajectory 42. To correct such positional deviations, the second learner 15 calculates errors of the individual segments of a correction trajectory 43 on the basis of the errors of the individual segments of the actual trajectory 41, and then calculates a correction trajectory 43 on the basis of the calculated errors and the positions of the corresponding segments of the ideal trajectory 42.

In detail, the second learner 15 calculates a correction trajectory 43 in which an error 44 of each segment illustrated in FIG. 11B, in other words, an error 44 at each point has a value of −κE. E indicates a value of an error 45 of the actual trajectory 41 at a point corresponding to that of the correction trajectory 43. κ is a factor having a value larger than 0 and smaller than 1, which is designed to prevent the correction trajectory 43 from diverging in the calculations.

These calculations allow the second learner 15 to acquire the correction trajectory 43 illustrated in FIG. 11D, which has a distribution of the errors 44 illustrated in FIG. 11C.

After the calculation of the correction trajectory 43, the second learner 15 determines whether the errors 45 of the actual trajectory 41 are at most an allowable limit, as illustrated in FIG. 9 (Step S25). In detail, the second learner 15 determines whether the largest error 45 among the errors 45 of the actual trajectory 41 at the individual points is at most the allowable limit. In this step, the second learner 15 determines whether the original piece of data on the trajectory indicated by the second learning data set 28 is acceptable before being corrected using the correction trajectory 43.

When determining that any of the errors 45 of the actual trajectory 41 exceeds the allowable limit (Step S25; No), the second learner 15 counts the number of failures of exceedance of the error 45 over the allowable limit (Step S26), and determines whether the counted number of failures is a predetermined number or smaller (Step S27). When determining that the number of failures is larger than the redetermined number (Step S27; No), the second learner 15 concludes that the process is in a failure mode of inevitable divergence of calculations, and terminates the second subprocess. In this case, the second learner 15 causes a display, which is not illustrated, included in the operation terminal 20 to display a failure mode.

In contrast, when the second learner 15 determines that the number of failures is the predetermined number or smaller (Step S27; Yes), the second leaner 15 finds no divergence of the calculations, and returns to Step S22. In Step S22, the trajectory determiner 12 regards the piece of data on the correction trajectory 43 calculated in Step S24, as the second learning data set 28. The second learner 15 then repeats Steps S23 to S27, and thus continuously corrects the trajectory indicated by the second learning data set 28 read in Step S21. The second learner 15 thus makes the actual trajectory 46 defined by the movement of the robot 10 in accordance with the correction trajectory 43, more approximate to the ideal trajectory 42, for example, as illustrated in FIG. 11E. The second learner 15 searches for a correction trajectory 43 in which errors 45 are at most the allowable limit.

Referring back to Step S25 in FIG. 9, when the second learner 15 determines that the errors 45 of the actual trajectory 41 are at most the allowable limit (Step S25; Yes), the second learner 15 generates a second correction model (Step S28). In detail, although the learning process involves calculation of a correction trajectory 43 as many times as the number of execution of Step S24, the second learner 15 calculates, on the basis of the calculated correction trajectory 43, a piece of data for correcting the ideal trajectory 42 indicated by the second learning data set 28 acquired in Step S21, and regards the calculated piece of data for correction as a second correction model. The second learner 15 thus generates a second correction model based on the positional deviations of the actual trajectory 41 from the individual points of the ideal trajectory 42 and based on the ideal trajectory 42. The second learner 15 then causes the generated second correction model to be stored into the learned data storage 19.

After the generation of the second correction model, the second learner 15 terminates the second subprocess.

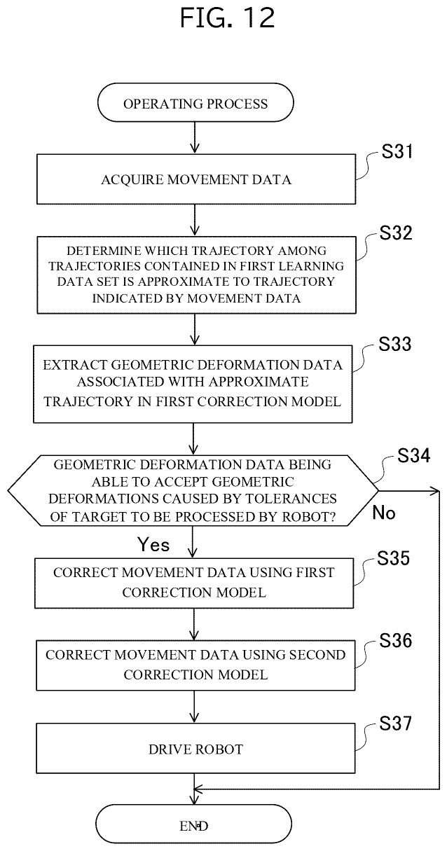

The following describes an operating process using the first correction model and the second correction model, with reference to FIG. 12.

FIG. 12 is a flowchart illustrating the operation process executed by the control device 1.

The user first inputs an operating instruction through the input unit of the operation terminal 20. In response to input of the operating instruction, the processor 31 of the control device 1 reads and executes the operating program stored in the memory 32. The execution of the operating program initiates the operating process.

In the operating process, the data acquirer 11 first acquires a piece of movement data on the robot 10, as illustrated in FIG. 12 (Step S31). The acquisition of the piece of movement data by the data acquirer 11 involves, for example, acquiring a piece of movement data on a desired movement of the robot 10, which is input through the input unit of the operation terminal 20.

The ideal trajectory 42, expected to be defined when the robot 10 performs an ideal movement in accordance with this piece of movement data, is preferably approximate to the standard trajectory contained in the first learning data set 27 preliminarily learned by the control device 1. Such a piece of movement data can improve the accuracy of the trajectory of the robot 10 as a result of learning by the first learner 14 and the second learner 15.

The acquisition of the piece of movement data by the data acquirer 11 may involve reading a piece of movement data preliminarily stored in a storage device, which is not illustrated. In this case, the storage device, which is not illustrated, may be the first learning data storage 17, the second learning data storage 18, or the learned data storage 19.

The piece of movement data may be acquired by other procedures. In an exemplary case where the robot system 100 includes an imaging unit and an image analysis unit that analyzes data on an image captured by the imaging unit, the imaging unit may capture an image of a work to be processed by the tool attached to the flange 170 of the robot 10, and the image analysis unit may calculate a position of the work from the image captured by the imaging unit, and then generate a piece of movement data. In this case, the image analysis unit extracts distinctive characteristics of the work, and generates a piece of movement data on the basis of the positions of the extracted distinctive characteristics in the image and the position of the imaging unit relative to the work.

After the acquisition of the piece of movement data in Step S31, the trajectory determiner 12 determines which trajectory, among the trajectories contained in the first learning data set 27 used in the learning process, is approximate to the trajectory indicated by the piece of movement data, through calculations (Step S32).

The following description focuses on the example illustrated in FIG. 7. The first learning data set 27 contains the trajectories No. 0 to No. 3, as illustrated in FIG. 7. In the case where the pieces of geometric deformation data of the first correction model indicate mappings f0, f1, f2, and f0 for geometric transformation, the mappings f0, f1, f2, and f0 are represented as below:
f0: A0→B, f1: A1→B, f2: A2→B, f3: A3→B
   where A0, A1, A2, and A3 are the respective trajectories illustrated in FIG. 7, and B is the ideal trajectory 42. In order to transform a trajectory C indicated by the piece of movement data into the trajectory B corresponding to the ideal trajectory 42, required is a mapping g represented as below:
g: C→B
   That is, by determining which trajectory among the trajectories A0, A1, A2, and A3 indicated by the first learning data set 27 is most approximate to the trajectory C indicated by the piece of movement data, one of the mappings f0, f1, f2, and f0 associated with the determined trajectory is found to be approximate to the mapping g.

In Step S32 in FIG. 12, the trajectory determiner 12 determines which trajectory among the trajectories contained in the first learning data set 27 is approximate to the trajectory indicated by the piece of movement data acquired in Step S31. In the above-described example, the trajectory determiner 12 determines which trajectory among the trajectories A0, A1, A2, and A3 is approximate to the trajectory indicated by the piece of movement data. The trajectory determiner 12 determines approximation of the trajectories contained in the first learning data set 27, for example, by fitting.

After the determination of the approximate trajectory, the trajectory determiner 12 reads the first correction model from the learned data storage 19. The trajectory determiner 12 then extracts the piece of geometric deformation data associated with the approximate trajectory, from the read first correction model (Step S33).

The ideal trajectory 42 is intended to cause a processing tool attached to the flange 170 of the robot 10 to shift along the processed shape of a processing target, for example, the processed shape of a product or component, for example. The learned data storage 19 preliminarily stores pieces of geometric deformation data on trajectories inferred by the examinations to occur due to tolerances of the processing target. After extraction of the piece of geometric deformation data, the trajectory determiner 12 determines whether the extracted piece of geometric deformation data can accept geometric deformations caused by tolerances of the target to be processed by the robot 10 (Step S34). That is, the trajectory determiner 12 determines whether the extracted piece of geometric deformation data indicates a larger correction than an assumed piece of data for correcting the geometric deformations caused by tolerances of the target to be processed by the robot 10.

When determining that the extracted piece of geometric deformation data cannot accept geometric deformations caused by tolerances of the target to be processed by the robot 10 (Step S34; No), which means that the extracted piece of geometric deformation data cannot correct even geometric deformations caused by tolerances of the target to be processed by the robot 10 or geometric deformations corresponding to dispersions from the designed value of the processing target, the trajectory determiner 12 concludes that the data for correction is insufficient, and terminates the operating process. The trajectory determiner 12 then causes the display included in the operation terminal 20 to display a failure mode.

In contrast, when the trajectory determiner 12 determines that the extracted piece of geometric deformation data can accept geometric deformations caused by tolerances of the target to be processed by the robot 10 (Step S34; Yes), the trajectory determiner 12 corrects the piece of movement data using the first correction model (Step S35). In detail, the trajectory determiner 12 corrects the piece of movement data acquired in Step S31 using the piece of geometric deformation data extracted from the first correction model.

The trajectory determiner 12 then corrects the piece of movement data using the second correction model (Step S36). That is, the trajectory determiner 12 corrects the piece of movement data acquired in Step S31 using the second correction model.

After the correction of the piece of movement data using the second correction model, the controller 13 drives the robot 10 in accordance with the piece of corrected movement data (Step S37). In detail, the controller 13 causes each of the motors M1 to M6 to rotate, in accordance with the trajectory indicated by the piece of corrected movement data. The control device 1 thus approaches the actual trajectory 41 of the robot 10 to the ideal trajectory 42, and corrects the deviations of the actual trajectory 41 from the ideal trajectory 42. The robot 10 thus moves with high accuracy.

After the movement of the robot 10, the controller 13 terminates the operating process.

The trajectory determiner 12 and the controller 13 described above in Embodiment 1 are examples of a robot controller according to the present disclosure. The motors M1 to M6 are examples of motors according to the present disclosure. The learning program and the operating program are examples of a program according to the present disclosure. The section of the trajectory acquirer 16 that calculates a trajectory of the robot 10 from the rotational positions of the motors M1 to M6 detected by the encoders E1 to E6 is an example of a first trajectory calculator according to the present disclosure.

The standard trajectory described above with reference to FIG. 7 is an example of an operational trajectory according to the present disclosure. The movement start point and the movement end point of each trajectory and the trajectory contained in the first learning data set 27 described above with reference to FIG. 7, are examples of a first learning movement start point, a first learning movement end point, and a first learning trajectory according to the present disclosure. The trajectory generated through geometric deformation of the standard trajectory contained in the first learning data set 27 is an example of a deformed trajectory according to the present disclosure.

As described above, the trajectory determiner 12 of the control device 1 according to Embodiment 1 calculates a piece of corrected movement data, using the first correction model for reducing a geometric deformation, which is generated by the first learner 14. The control device 1 controls the robot 10 in accordance with the piece of corrected movement data calculated by the controller 13. The control device 1 thus reduces the geometric deformation of the trajectory of the robot 10. The control device 1 can therefore cause the robot 10 to move with high accuracy.

The trajectory determiner 12 of the control device 1 corrects the piece of movement data, using the first correction model for reducing the positional deviations of the individual segments of a trajectory, which is generated by the second learner 15. The control device 1 thus reduces the deformation of the individual segments of the trajectory of the robot 10. The control device 1 can therefore cause the robot 10 to move with high accuracy.

Although the above description does not refer to a processor or an interface included in the robot 10, the robot 10 may include a processor and an interface. This interface may be connected to a communication module, and allow the robot 10 to communicate with the control device 1 via a network, such as the Internet.

Although the first learning data set 27 described above in Embodiment 1 associates pieces of movement data for defining trajectories with geometric deformation conditions of the trajectories, the geometric deformation conditions preferably encompass geometric deformations of trajectories expected to occur due to tolerances of the target to be processed by the robot 10. Such geometric deformation conditions can correct the deviations of a trajectory caused by tolerances of the processing target.

### Embodiment 2

In Embodiment 1, the second learner 15 calculates a correction trajectory 43, in which the error 44 of each segment has a value of E multiplied by a constant of −κ, where E indicates a value of the error 45 of the corresponding segment of the actual trajectory 41 of the robot 10, in Step S24, and thus generates a second correction model. The second learner 15, however, may have another configuration. The second learner 15 is only required to calculate positional deviations of the individual segments of the actual trajectory 41 of the robot 10 from the corresponding segments of the ideal trajectory 42, on the basis of a piece of data on a second trajectory corresponding to the actual trajectory 41 of the robot 10 controlled by the controller 13 in accordance with the second learning data set 28 acquired by the data acquirer 11, and on the basis of a piece of data on a second ideal trajectory corresponding to the ideal trajectory 42 preferably defined by a movement of the robot 10, and generate a second correction model for reducing the calculated positional deviations on the basis of the calculated positional deviations and the second learning data set 28. That is, the positional deviations may be calculated by any procedure, in other words, the second correction model may be generated by any procedure, provided that these requirements are satisfied.

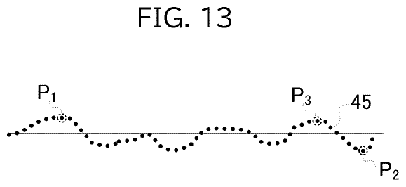

In Embodiment 2, the second learner 15 calculates a correction trajectory 43 using an optimization algorithm, and thus generates a second correction model. The following describes a second subprocess involved in a learning process executed by the control device 1 according to Embodiment 2, with reference to FIG. 13. The description of Embodiment 2 is mainly directed to the differences from Embodiment 1.

The control device 1 according to Embodiment 2 executes the first subprocess and the second subprocess of the learning process described above in Embodiment 1. In the second subprocess, the second learner 15 of the control device 1 calculates errors 45 of the individual segments of the actual trajectory 41 of the robot 10, that is, errors 45 at the individual points, and calculates a correction trajectory 43 from the calculated errors 45 using an optimization algorithm, in Step S24. The second learner 15 then generates a second correction model from the calculated correction trajectory 43.

FIG. 13 is a conceptual diagram illustrating a distribution of the errors 45 of the actual trajectory 41 used in the second subprocess.

In detail, from among the errors 45 of the actual trajectory 41, which is acquired by the trajectory acquirer 16 in Step S23, at the individual points P₁, P₂, P₃, . . . and P_{M} relative to the ideal trajectory 41 at the corresponding points, the second learner 15 selects one of the points P₁, P₂, P₃, . . . , and P_{N} in the descending order of the errors 45, as illustrated in FIG. 13.

N is a predetermined natural number smaller than M, which indicates the number of sampled points of the actual trajectory 41. FIG. 13 illustrates an exemplary case of N=3.

The second learner 15 then establishes an evaluation function. For example, the second learner 15 defines an evaluation function f represented by Expression (1) below:

$$f = {G}_{1} + {G}_{2} + {G}_{3} + … + {G}_{N} \qquad ( 1 )$$

where G₁, G₂, G₃, . . . , and GN are values of the errors 45 of the actual trajectory 41 at the respective points P₁, P₂, P₃, . . . , and P_{N}, and f indicates an evaluation function.

The second learner 15 then searches for the points P₁, P₂, P₃, . . . , and P_{N} providing a smaller evaluation function f, using the optimization algorithm. Preferable examples of the optimization algorithm include Bayesian optimization algorithm and particle swarm optimization algorithm. In an exemplary case of the Bayesian optimization algorithm applied as the optimization algorithm, N is preferably equal to or larger than 1 and equal to or smaller than 10. In another exemplary case of the particle swarm optimization algorithm applied as the optimization algorithm, N is preferably equal to or larger than 10.

When the second learner 15 finds the points P₁, P₂, P₃, . . . , and P_{N} providing a smaller evaluation function f, the second learner 15 calculates a correction trajectory 43 from the found points P₁, P₂, P₃, . . . , and P_{N}. The second learner 15 then generates a second correction model from the calculated correction trajectory 43, by the specific procedure in Step S28 described above in Embodiment 1.

Alternatively, the evaluation function may be a function representing the volume of a three-dimensional body depicted by rotating the graph representing values of the errors 45 of the actual trajectory 41 at the individual points P₁, P₂, P₃, . . . , and P_{N} about the axis representing an error of 0.

As described above, the second learner 15 of the control device 1 according to Embodiment 2 calculates a correction trajectory 43 using the optimization algorithm, and thus generates a second correction model. The second learner 15 can thus generate a second correction model with a smaller number of trials than that in the generation of a second correction model in Embodiment 1.

Alternatively, instead of the calculation of errors 45 of the individual segments of the actual trajectory 41 and the calculation of a correction trajectory 43, the distinctive characteristics of a distribution of the errors 45 of the individual segments may be detected, followed by calculation of a correction trajectory 43 from the distinctive characteristics. For example, the peaks of the graph representing a distribution of the errors 45 of the individual segments of the actual trajectory 41 may be detected, and a correction trajectory 43 providing smaller peaks may be calculated using the Bayesian optimization algorithm of machine learning. These alternative procedures can further reduce the time required for calculations.

The control device 1, the robot system 100, the learning device, the method of controlling the robot 10, and the program according to Embodiment 1 of the present disclosure described above are mere examples and may have other configurations.

For example, the second learner 15 calculates positional deviations of the individual segments of the actual trajectory 41 from the corresponding segments of the ideal trajectory 42 uniformly across the entire trajectory in Embodiments 1 and 2. This example, however, is not to be construed as limiting the scope of the control device, the robot system, the learning device, the method of controlling a robot, and the program.

Although the control device 1 includes the first learner 14 and the second learner 15 in Embodiments 1 and 2, the control device 1 may have another configuration. The control device 1 may include the first learner 14 and exclude the second learner 15. In this case, the controller 13, when controlling the robot 10 in accordance with a piece of movement data acquired by the data acquirer 11, corrects the piece of movement data using the first correction model, thus calculates a piece of corrected movement data, and controls the robot 10 in accordance with the piece of corrected movement data. This modification can also reduce the geometric deformation of the trajectory of the robot 10, and allow the robot 10 to move with high accuracy.

Although the encoders E1 to E6 measure a trajectory of the robot 10 in Embodiments 1 and 2, these examples are not to be construed as limiting the scope of the measurement device for measuring a trajectory of the robot 10. The robot system 100 is only required to include a measurement device for measuring a trajectory of the robot 10, and cause the first learner 14 to acquire the trajectory of the robot 10 from this measurement device. The measurement device may also be a specific device other than the encoders E1 to E6, provided that these requirements are satisfied. The measurement device may include an imaging unit that captures an image of the robot 10, and a trajectory calculator that calculates a trajectory of the robot 10 from the image captured by the imaging unit and location information on the imaging unit.

Although the description of Embodiment 1 refers to the modified robot system 100 including the imaging unit for acquiring apiece of movement data, this imaging unit may also be called a first imaging unit. In contrast, the imaging unit included in the measurement device for measuring a trajectory of the robot 10 may also be called a second imaging unit. The trajectory calculator, which calculates a trajectory of the robot 10 from the image captured by the imaging unit and location information on the imaging unit, may also be called a second trajectory calculator, while the section of the trajectory acquirer 16 that calculates a trajectory of the robot 10 from the rotational positions of the motors M1 to M6 detected by the encoders E1 to E6 may also be called a first trajectory calculator.

Although the first learning data set 27 contains a single standard trajectory and multiple trajectories generated through geometric deformation of the standard trajectory in Embodiments 1 and 2, this first learning data set 27 is a mere example. The first learning data set 27 may contain any number of standard trajectories and any number of trajectories generated through geometric deformation of the standard trajectories. For example, the first learning data set 27 may contain multiple standard trajectories. The number of trajectories generated through geometric deformation of the standard trajectories may be larger or smaller than the number illustrated above in the embodiments.

Although Embodiments 1 and 2 are applied to the vertical articulated robot 10, the present disclosure may also be applied to any of general robots. The robot 10 may be a horizontal articulated robot, for example. The robot 10 may also be an orthogonal robot made of a combination of uniaxial prismatic units.

Although the trajectories of the robot 10, in detail, the trajectories of the flange 170 are defined on the basis of the orthogonal coordinate system XYZ in Embodiments 1 and 2, the trajectories may also be defined on the basis of a cylindrical coordinate system.

Although the operating program and the learning program are stored in the memory 32 in the above embodiments, these programs may also be stored in a non-transitory computer-readable recording medium, such as flexile disc, compact disc read-only memory (CD-ROM), digital versatile disc (DVD), or magneto-optical disc (MO), and distributed. In this case, the operating program and the learning program stored in the non-transitory recording medium may be installed in a computer, and thus configure the control device 1 that executes the operating process and the leaning process.

The operating program or the learning program may also be stored in a disk drive included in a server device on a communication network, such as the Internet, and may be downloaded into a computer by being superimposed on a carrier wave, for example. Alternatively, the operating program or the leaning program may be activated while being transferred through a communication network, and thus perform the operating process and the learning process. A server device may execute all or part of the operating program or the learning program, and a computer may execute the program while transmitting and receiving information on the executed processes to and from the server device via a communication network, and thus perform the operating process or the learning process.

In the case where the operating process or the learning process is achieved by an operating system (OS) or by cooperation of the OS and applications, only the components other than the OS may be stored in a medium for distribution or downloaded into a computer, for example. The functions of the control device 1 may also be performed by means other than software. Part or all of the functions may be performed by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-81457, filed on May 18, 2022, the entire disclosure of which is incorporated by reference herein.

### REFERENCE SIGNS LIST

1 Control device
10 Robot
11 Data acquirer
12 Trajectory determiner
13 Controller
14 First learner
15 Second learner
16 Trajectory acquirer
17 First learning data storage
18 Second learning data storage
19 Learned data storage
20 Operation terminal
27 First learning data set
28 Second learning data set
31 Processor
32 Memory
33 Interface
34 Bus
41 Actual trajectory
42 Ideal trajectory
43 Correction trajectory
44, 45 Error
46 Actual trajectory
100 Robot system
110 Base
120 First arm
130 Second arm
140 Third arm
150 Fourth arm
160 Fifth arm
170 Flange
180 Stabilizer
AX1-AX6 Axis
E1-E6 Encoder
M1-M6 Motor
P₁, P₂, P₃ Point

1. A control device, comprising:
at processor to acquire
a piece of movement data indicating an operational trajectory of a robot including at least a movement start point at which the robot starts a movement and a movement end point at which the robot ends the movement, or
a first learning data set containing a piece of data indicating a first learning trajectory of the robot including at least a first learning movement start point at which the robot starts a movement and a first learning movement end point at which the robot ends the movement,
control the robot in accordance with the piece of movement data or the first learning data set, and
calculate, from a piece of data on a first trajectory and a piece of data on a first ideal trajectory, a geometric deformation of the first trajectory relative to the first ideal trajectory, the first trajectory being an actual trajectory actually defined by a movement of the robot and the first ideal trajectory being an ideal trajectory preferably defined by a movement of the robot when the robot is controlled in accordance with the first learning data set, and
generate, based on the calculated geometric deformation and the piece of data contained in the first learning data set, a first correction model for correcting the piece of movement data and thus reducing the calculated geometric deformation, wherein
when the processor controls the robot in accordance with the piece of movement data, the processor
corrects the piece of movement data using the first correction model, and thus calculates a piece of corrected movement data, and
controls the robot in accordance with the piece of corrected movement data.

2. The control device according to claim 1, wherein
the first learning data set contains, in addition to the piece of data indicating the first learning trajectory of the robot, at least one piece of data indicating at least one deformed trajectory generated through geometric deformation of the first learning trajectory,
the processor generates the first correction model in association with each of the first learning trajectory and the at least one deformed trajectory, and
when the processor controls the robot in accordance with the piece of movement data, the processor
determines which trajectory, among the first learning trajectory and the at least one deformed trajectory, is approximate to the operational trajectory indicated by the piece of movement data,
corrects the piece of movement data using the first correction model associated with the trajectory determined to be approximate, and
thus calculates a piece of corrected movement data.

3. The control device according to claim 1, wherein the geometric deformation is
a deformation generated through rotation, magnification or demagnification, or translation of the first ideal trajectory, or
a deformation generated through a combination of rotation, magnification or demagnification, and translation of the first ideal trajectory.

4. The control device according to claim 1, wherein
the processor
acquires at least one of the piece of movement data, the first learning data set, or a second learning data set indicating the operational trajectory,
controls the robot in accordance with the at least one of the piece of movement data, the first learning data set, or the second learning data set,
calculates, from a piece of data on a second trajectory and a piece of data on a second ideal trajectory, positional deviations of individual segments of the second trajectory from corresponding segments of the second ideal trajectory, the second trajectory being an actual trajectory actually defined by a movement of the robot and the second ideal trajectory being an ideal trajectory preferably defined by a movement of the robot when the robot is controlled in accordance with the second learning data set, and
generates, based on the calculated positional deviations and the second learning data set, the second correction model for reducing the calculated positional deviations, and
when the processor controls the robot in accordance with the piece of movement data,
corrects the piece of movement data using the first correction model and then further corrects the piece of movement data using the second correction model, and thus calculates a piece of corrected movement data, and
controls the robot in accordance with the piece of corrected movement data.

5. The control device according to claim 4, wherein the processor generates the second correction model using an optimization algorithm.

6. A robot system, comprising:
a robot; and
the control device according to claim 1.

7. The robot system according to claim 6, further comprising:
a first imaging unit; and
an image analysis unit to analyze an image captured by the first imaging unit, wherein
the robot includes a tool,
the first imaging unit captures an image of a work to be processed by the tool,
the image analysis unit
extracts distinctive characteristics of the work from the image captured by the first imaging unit, and
calculates, from location information on the first imaging unit and positions of the extracted distinctive characteristics in the image, a piece of movement data, and
the processor acquires the piece of movement data from the image analysis unit.

8. The robot system according to claim 6, further comprising:
a measurement device to measure the first trajectory of the robot, wherein
the processor acquires the first trajectory from the measurement device.

9. The robot system according to claim 8, wherein
the robot includes
links, and
motors to turn the respective links, and
the measurement device includes
encoders to detect respective rotational positions of the motors, and
a first trajectory calculator to calculate, from the rotational positions detected by the encoders, the first trajectory of the robot.

10. The robot system according to claim 8, wherein the measurement device includes
a second imaging unit to capture an image of the robot, and
a second trajectory calculator to calculate, from the image captured by the second imaging unit and location information on the second imaging unit, the first trajectory of the robot.

11. The robot system according to claim 6, further comprising:
a storage device to store the piece of movement data, wherein
the processor acquires the piece of movement data from the storage device.

12. The robot system according to claim 11, wherein
the storage device further stores the first learning data set, and
the processor acquires the first learning data set from the storage device.

13. The robot system according to claim 6, further comprising:
an operation terminal including an input unit through which the piece of movement data is input, wherein
the processor acquires the piece of movement data from the operation terminal.

14. A learning device comprising a second processor to generate a first correction model for correcting a piece of movement data acquired by a control device, the control device including a first processor to
acquire a piece of movement data indicating an operational trajectory of a robot including at least a movement start point at which the robot starts a movement and a movement end point at which the robot ends the movement, and
control the robot in accordance with the piece of movement data acquired by the first processor, wherein
the second processor
calculates, from a piece of data on a first trajectory and a piece of data on a first ideal trajectory, a geometric deformation of the first trajectory relative to the first ideal trajectory, the first trajectory being an actual trajectory actually defined by a movement of the robot and the first ideal trajectory being an ideal trajectory preferably defined by a movement of the robot when the first processor controls the robot in accordance with a first learning data set acquired by the first processor, the first learning data set containing a piece of data indicating a first learning trajectory of the robot including at least a first learning movement start point at which the robot starts a movement and a first learning movement end point at which the robot ends the movement, and
generates, based on the calculated geometric deformation and the piece of data contained in the first learning data set, the first correction model for correcting the piece of movement data and thus reducing the calculated geometric deformation.

15. The learning device according to claim 14, wherein
the first learning data set contains, in addition to the piece of data indicating the first learning trajectory of the robot, at least one piece of data indicating at least one deformed trajectory generated through geometric deformation of the first learning trajectory, and
the second processor generates the first correction model in association with each of the first learning trajectory and the at least one deformed trajectory.

16. The learning device according to claim 14, wherein the geometric deformation in generation of the first correction model is
a deformation generated through rotation, magnification or demagnification, or translation of the first ideal trajectory, or
a deformation generated through a combination of rotation, magnification or demagnification, and translation of the first ideal trajectory.

17. The learning device according to claim 14, wherein
the second processor
calculates, from a piece of data on a second trajectory and a piece of data on a second ideal trajectory, positional deviations of individual segments of the second trajectory from corresponding segments of the second ideal trajectory, the second trajectory being an actual trajectory actually defined by a movement of the robot and the second ideal trajectory being an ideal trajectory preferably defined by a movement of the robot when the first processor controls the robot in accordance with a second learning data set acquired by the first processor, the second learning data set indicating the operational trajectory, and
generates, based on the calculated positional deviations and the second learning data set, a second correction model for reducing the calculated positional deviations.

18. The learning device according to claim 17, wherein the second processor generates the second correction model using an optimization algorithm.

19.-21. (canceled)

22. A non-transitory computer-readable recording medium storing a program, the program configured to cause a computer for controlling a robot to execute:
a step of
controlling the robot in accordance with a first learning data set, the first learning data set containing a piece of data indicating a first learning trajectory of the robot including at least a first learning movement start point at which the robot starts a movement and a first learning movement end point at which the robot ends the movement, and
measuring a first trajectory, the first trajectory being an actual trajectory actually defined by a movement of the robot when the robot is controlled in accordance with the first learning data set;
a step of
calculating, from a piece of data on the first trajectory and a piece of data on a first ideal trajectory, a geometric deformation of the first trajectory relative to the first ideal trajectory, the first ideal trajectory being an ideal trajectory preferably defined by a movement of the robot, and
generating, based on the calculated geometric deformation and the first learning data set, a first correction model for reducing the calculated geometric deformation;
a step of
correcting a piece of movement data using the first correction model, the piece of movement data containing at least a movement start point at which the robot starts a movement and a movement end point at which the robot ends the movement, and
thus calculating a piece of corrected movement data; and
a step of controlling the robot in accordance with the piece of corrected movement data calculated in the step of calculating a piece of corrected movement data.
